(19) United States
(12) Patent Application Publication
(10) Pub. No.: US 2007/0134401 A1
(43) Pub. Date: Jun. 14, 2007

(54) Cooking process of red bean porridge without a bitter taste

(75) Inventors: Chang Yong Lee, Seoul (KR); Jong Wook Kim, Seoul (KR); Heon Woong Jung, Seoul (KR)

Correspondence Address: BIRCH STEWART KOLASCH & BIRCH, PO BOX 747, FALLS CHURCH, VA, 22040-0747, US

(73) Assignee: CJ CORP.

(21) Appl. No.: 11/635,645

(22) Filed: Dec. 8, 2006

(30) Foreign Application Priority Data
Dec. 9, 2005 (KR) 10-2005-0120706

(51) Int. Cl. A23L 1/20

(52) U.S. Cl. 426/634

(57) ABSTRACT

Disclosed is a cooking process of red bean sediment for reducing an unpleasant and slightly bitter aftertaste of red beans by removing tannins and saponins contained in red beans through repetition of a water changing operation, a cooking process of red bean porridge with the red bean sediment, and red bean porridge. The cooking process provides enhanced sensory attributes in terms of color and taste of the red bean porridge by minimizing contents of tannin and saponin causing the unpleasant aftertaste of the red bean porridge through a number of water changing operations between boiling of red beans.

### CROSS-REFERENCE TO RELATED APPLICATIONS

This application claims benefit under 35 U.S.C. § 119 from Korean Patent Application No. 10-2005-0120706, filed on Dec. 9, 2005, the entire content of which is incorporated herein by reference.

### BACKGROUND OF THE INVENTION

1. Field of the Invention

The present invention relates in general to a cooking process of red bean sediment, a cooking process of red bean porridge with red bean sediment, and red bean porridge. More specifically, the present invention relates to a cooking process of red bean sediment for reducing an unpleasant and slightly bitter aftertaste of red beans by removing tannins and saponins contained in red beans through repetition of a water changing operation, a cooking process of red bean porridge with the red bean sediment, and red bean porridge.

2. Description of the Related Art

In general, red beans are known to have a considerable amount of saponins and tannins. To cook red bean porridge, one adds a certain amount of water to beans and simmers the beans for at least 60 minutes at a temperature of around 100° C. until they are tender and viscous to a certain extent. Unfortunately, saponins and tannins are not removed during cooking but remain in the finished products. The saponins and tannins leave a bitter and puckery taste in one's mouth when eating the red bean porridge. In particular, when porridge is prepared into a retort packaged meal through retorting, the saponins and tannins negatively affect food quality accompanied with sensory quality during retorting.

### SUMMARY OF THE INVENTION

It is, therefore, an object of the present invention to provide a cooking process of red bean porridge for minimizing contents of tannin and saponin in the red bean porridge, thereby reducing bitter and puckery aftertastes and an enhanced sensory quality. Compared with conventional cooking where red beans were simply simmered in water, the cooking process of the present invention first carried out the preprocessing on red beans to thereby prepare red bean sediment with reduced tannins and saponins, and produced red bean porridge using the red bean sediment as an ingredient. Through a sensory test and an analysis of tannin and saponin contents in the red bean sediment, the inventors confirmed that the inventive red bean porridge does not leave bitter and puckery aftertastes and exhibit superior sensory attributes.

To achieve the above objects and advantages, there is provided a cooking process of red bean porridge made of red bean sediment that is prepared by using preprocessed red beans, which the method is characterized by two things: (1) Contents of saponin and tannin causing bitter and a puckery aftertastes of red bean porridge are minimized by changing water during a boiling (smothering) process, and (2) Instead of stewing whole red beans and water (and/or rice) together on low heat in a conventional cooking process of red bean porridge, red beans of the present invention are crushed and processed in advance to make red bean sediment which is then stirred and heated until well blended with water to cook red bean porridge. After conducting a sensory test repeatedly on the red bean porridge of the invention, a team of professional sensory analysts drew a conclusion that the red bean porridge left no bitter and unpleasant tastes behind but had a good taste and an enhanced sensory quality.

Aftertaste of the red bean porridge can be traced by checking contents of tannin and saponin in the red bean sediment.

Content of coarse tannin in a red bean was determined as follows:

80% ethanol was added to red beans to cause extraction at 75° C. The extract solution was condensed at the same temperature under reduced pressure and a concentrated ethanol extract was thus obtained. Then, the ethanol extract was divided into an aqueous layer and an ether layer by addition of water and ether. The aqueous layer was extracted with water-saturated butanol to thereby obtain a butanol extract. The butanol extract was then condensed at 70° C. under reduced pressure and dried to be subject to the mass measurement of coarse tannin in the red bean.

Meanwhile, content of tannin in the red bean was determined as follows:

The coarse tannin thus obtained was extracted with methanol at room temperature to thereby obtain a methanol extract. The methanol extract was then mixed with Folin-Ciocalteu reagent to produce an extract mixture, and 10% Na₂CO₃ was added to the extract mixture for reaction at room temperature. A resulting compound (i.e., tannin) was subject to an absorbance measurement at 700 nm wavelength. Wherein, standard material is 5˜50 μg/ml of tannic acid.

Similarly, content of coarse saponins in a red bean was determined as follows:

80% ethanol was added to red beans to cause extraction at 75° C. The extract solution was condensed at the same temperature under reduced pressure and a concentrated ethanol extract was thus obtained. Then, the ethanol extract was divided into an aqueous layer and an ether layer by addition of water and ether. The aqueous layer was extracted with water-saturated butanol to thereby obtain a butanol extract. The butanol extract was then condensed at 70° C. under reduced pressure and dried to be subject to the mass measurement of coarse saponins in the red bean.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above aspects and features of the present invention will be more apparent by describing certain embodiments of the present invention with reference to the accompanying drawings, in which:

FIG. 1 is a flow chart for sequentially describing a cooking process of red bean porridge of the present invention and retort processing operations thereof;

FIG. 2 is a graph showing results of a sensory test on red bean porridges according to various embodiments of the present invention; and

FIG. 3 graphically compares contents of coarse tannin, tannin, coarse saponin, and ginsenoside in domestically grown red beans and in red bean sediment made from the same.

### DETAILED DESCRIPTION OF THE PREFERRED EMBODIMENTS

A cooking process of red bean porridge according to a preferred embodiment of the present invention will be described herein below with reference to the accompanying drawings.

The cooking process of red bean porridge is made from a precooked red bean sediment that is prepared by: rinsing red beans (Adzuki), boiling the red beans in warm water (1^{st} boiling step), soaking the boiled red beans in room temperature-water so as to elute saponins and tannins from the red beans, and boiling again the red beans in warm water (2^{nd} boiling step); draining the red beans having been boiled twice; crushing the drained red beans and processing them with a finisher; and changing water and dehydrating the processed red beans to obtain the red bean sediment.

Preferably, the step of crushing the drained red beans and processing them with a finisher is repeated two to four times, more preferably, two times.

The cooking process of red bean porridge of the present invention further includes: adding sugar to the prepared red bean sediment and stirring the mixture to thereby make sweetened red bean sediment; and adding water into the sweetened red bean sediment, and simmering and stirring it until red bean porridge is fully cooked reaching desired consistency.

The red bean porridge obtained by the cooking process of the present invention exhibits superior sensory attributes and especially contains substantially reduced amounts of saponins and tannins, thereby leaving no bitter and puckery aftertastes.

More preferably, the red bean sediment in need of cooking red bean porridge of the present invention is prepared by a cooking process including the steps as follows:

1^{st} step: rinsing red beans with water;

2^{nd} step: boiling the red beans in a predetermined amount of warm water (the 1^{st} boiling operation);

3^{rd} step: changing water and soaking the red beans in room temperature-water so as to elute saponins and tannins from the boiled red beans;

4^{th} step: boiling the red beans in warm water (the 2^{nd} boiling operation);

5^{th} step: thoroughly draining the red beans that had been boiled twice, and crushing the drained red beans (the 1^{st} crushing operation);

6^{th} step: separating husks of the crushed red beans and screening;

7^{th} step: processing the red beans by using a finisher (the 1^{st} processing operation);

8^{th} step: crushing the processed red beans (the 2^{nd} crushing operation);

9^{th} step: processing the red beans by using a finisher (the ₂nd processing operation);

10^{th} step: automatically changing water after completion of the second processing operation; and

11^{th} step: screening, draining, and obtaining red bean sediment.

Preferably, the first boiling process continues about 30 minutes given that the water temperature is approximately 100° C. Likewise, the second boiling process continues about 20 minutes under the same condition of temperature. The amount of time required for boiling may vary depending on the temperature of water.

Meanwhile, it is known that contents of tannin and saponin are decreased and the sensory attributes overall are enhanced as the number of times the water is changed (the 3^{rd} step) during the boiling process increases. However, taking both the amount of time and expense spent on the water changing processes and the taste improvement of red bean porridge as a result of the water changing process into consideration, the water changing process is preferably repeated about 3 times.

Once the red bean sediment is prepared by following the 1^{st} step to the 11^{th} step, (1) it is mixed with sugar and stirred until well blended to make a sweetened red bean sediment; and (2) a certain amount of the sweetened red bean sediment is gently simmered in water while being frequently stirred until red bean porridge is fully cooked. Other food additives may be added in order to enjoy enriched food of high quality.

The red bean porridge can be processed as a ready-to-eat food, e.g., a retort pouch food that can be served simply after reheating in microwave or after simmering in water. The retort process includes: (1) filling the red bean porridge having been cooked by stirring and simmering the sweetened red bean sediment in water into a retort pouch (heat-resistant vessel or equipment), sealing and packaging; and (2) sterilizing the sealed retort pouch at high temperature, or performing a retort sterilization process, to thereby produce retort red bean porridge. Preferably, the retort sterilization process is performed at a temperature of 110° C. to 125° C. for 25 to 35 minutes. The retort red bean porridge provides an enhanced food safety against microbial spoilage, and an extended shelf life longer than 12 months at room temperature

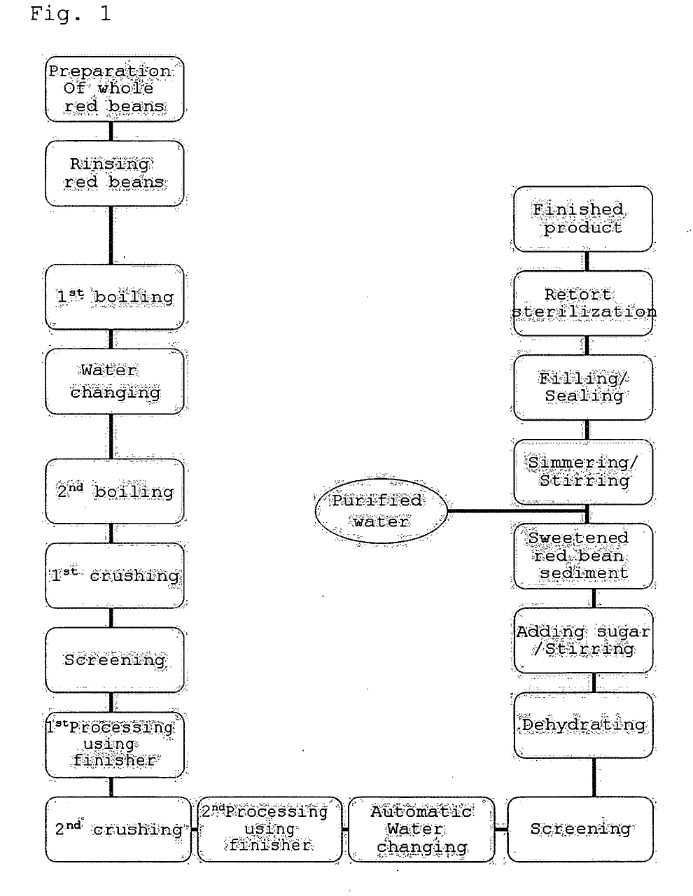

FIG. 1 sequentially describes a cooking process of red bean porridge of the present invention and retort processing operations thereof.

In particular, the red bean sediment of the present invention does not have an unpleasant aftertaste of red bean itself because contents of tannin and saponin are minimized. As such, the red bean sediment is expected to positively affect quality improvement not only for the red bean porridge as in the present invention, but also for other types of foods using red beans as their main ingredient.

Preferred examples described hereinafter are nothing but the ones provided to assist in a comprehensive understanding of the invention. Thus, it is apparent that the present invention is not limited thereto.

### EXAMPLE 1

1,000 g of whole red beans were rinsed with water five times, and boiled in water at 100° C. for 100 minutes. Then, husks of the red beans were removed to thereby prepare red bean sediment.

### EXAMPLE 2

1,000 g of whole red beans were rinsed with water five times, and boiled in water at 100° C. for 30 minutes. The boiled red beans were soaked in water at 20° C. (room temperature) for 2 hours. Next, the red beans were boiled again in water at 100° C. for 20 minutes, drained, crushed (the 1^{st} crushing operation), and subjected to screening. The crushed red beans were processed (the 1^{st} processing operation), crushed (the 2^{nd} crushing operation), and processed (the 2^{nd} processing operation). Then, operations such as automatic water changing, screening, and dehydrating operations were performed sequentially to make red bean sediment.

### EXAMPLE 3

The process used in Example 2 was carried out, except that the boiled red beans were soaked in water at 20° C. (room temperature) for 2 hours three times in a row.

### EXAMPLE 4

The process used in Example 2 was carried out, except that the boiled red beans were soaked in water at 20° C. (room temperature) for 2 hours five times in a row and the 2^{nd} processing operation was not performed after the 2^{nd} crushing operation.

### EXAMPLE 5

1,000 g of whole red beans were rinsed with water five times, and boiled in water at 100° C. for 30 minutes. Then, the boiled red beans were soaked in water at 20° C. (room temperature) for 2 hours six times in a row, and simmered again (the 2^{nd} boiling operation).

Each of the red bean sediments obtained from Examples 1-5 was mixed with sugar to make sweetened red bean sediments. 800 g of each sweetened red bean sediment was mixed with 250g of water and simmered in water at 95° C. for 10 minutes while being stirred. Then, 180 g of each of the red bean porridges was put into a retort pouch (heat resistant vessel) and sealed. The sealed pouch was put in hot water at 110-125° C., sterilized inside the retort for 25-35 minutes, and cooled, thereby producing retort red bean porridge.

### EXAMPLE 6

Red beans (A) produced in China and three kinds of red beans produced in Korea (B, C and D) were used as samples, and the same process used in Example 2 was carried out, except that the boiled red beans were soaked in water at 20° C. (room temperature) for 2 hours six times in a row and the 2^{nd} processing operation was not performed after the 2^{nd} crushing operation.

### Experimental Example 1

### Sensory Test

TABLE 1

| | Exp. 1 | Exp. 2 | Exp. 3 | Exp. 4 | Exp. 5 |
|---|---|---|---|---|---|
| Color | 3.6 | 3.8 | 4 | 4.2 | 4.2 |
| p-value | 0.022 | 0.031 | 0.023 | 0.061 | 0.021 |
| Mild taste | 3.7 | 3.7 | 3.9 | 3.9 | 3.9 |
| p-value | 0.031 | 0.025 | 0.042 | 0.214 | 0.042 |
| Smooth and light | 3.6 | 3.7 | 3.8 | 3.9 | 3.9 |
| taste | | | | | |
| p-value | 0.028 | 0.032 | 0.125 | 0.248 | 0.254 |
| Thick and puckery | 3.6 | 3.8 | 3.9 | 4 | 4.1 |
| taste | | | | | |
| p-value | 0.017 | 0.024 | 0.036 | 0.045 | 0.011 |
| Aftertaste | 3.5 | 3.7 | 3.9 | 4 | 4.1 |
| p-value | 0.035 | 0.031 | 0.026 | 0.044 | 0.001 |
| Overall taste | 3.6 | 3.7 | 3.9 | 4 | 4.2 |
| (including color) | | | | | |
| p-value | 0.021 | 0.013 | 0.038 | 0.045 | 0.042 |

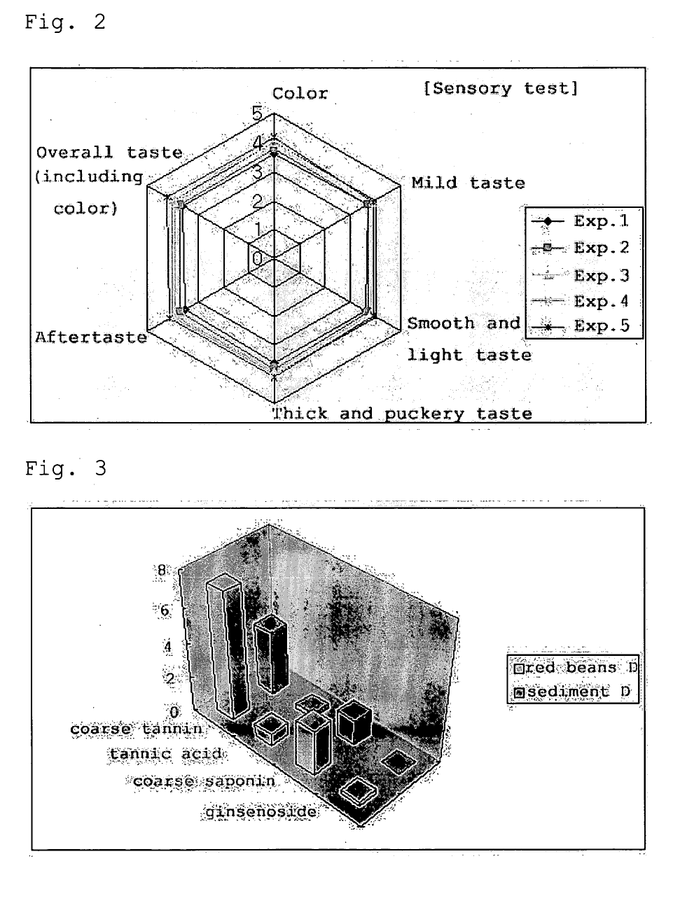

The sensory test results were expressed ranging from a low of 1 to a high of 5 (5: Excellent; 4: Good, 3: Fair, 2: Poor, 1: Very poor), and significant difference was in 95% CI. These results are plotted on the graph shown in FIG. 2.

As evident from the results, Example 1 where red beans were simply boiled without changing water shows a significantly low level of quality in aftertaste and thick and puckery taste. Test results of Examples 2-5 confirm that the aftertaste and the thick and puckery taste of the red bean porridges was reduced in inverse proportion to the frequency of changing water in which the red beans were soaked, and the overall taste of the red bean porridge turned out to be adversely affected by the aftertaste and the thick and puckery taste. To be short, the red bean porridge made from red bean sediment having undergone water changing operations had a reduced puckery aftertaste and exhibited an enhanced food quality. This phenomenon was more evident when the number of water changing operations was increased.

### Experimental Example 2

### Content Analysis of Tannin and Saponin

An analysis was made on contents of coarse tannin, tannin, and coarse saponin remaining in red bean sediments, each having been prepared from the four types of the red beans used in Example 6, respectively. In Table 2 below, Arabic numerals without parenthesis denote contents of target analytes, i.e., coarse tannin, tannin, coarse saponin, and ginsenoside, in whole red beans, while Arabic numerals in parenthesis denote contents of the same target analytes in the red bean sediments prepared by boiling and soaking operations.

TABLE 2

| | Red beans A | Red beans B | Red beans C | Red beans D |
|---|---|---|---|---|
| | (produced in | (produced in | (produced in | (produced in |
| | China) | Korea) | Korea) | Korea) |
| Coarse | 9.48 | 8.55 | 8.42 | 7.31 |
| tannin | (3.93) | (3.79) | (3.70) | (3.64) |
| Tannin | 0.86 | 0.80 | 0.77 | 0.71 |
| | (0.38) | (0.32) | (0.31) | (0.28) |
| Coarse | 2.81 | 2.92 | 2.74 | 2.61 |
| saponin | (1.53) | (1.55) | (1.50) | (1.47) |
| Ginsenoside | 0.22 | 0.24 | 0.22 | 0.20 |
| | (0.04) | (0.04) | (0.03) | (0.03) |

As can be seen from Table 2, red beans produced in China have higher contents of coarse tannin and coarse saponin than red beans produced in Korea. Therefore, one can expect that food quality of the red bean porridge made from Chinese red beans would be inferior to that of the red bean porridge made from Korean red beans. In addition, the result shows that contents of tannin and saponin in the red bean sediments are substantially lower than those in whole red beans. This confirms that most of the tannins and saponins in whole red beans were removed during preprocessing of the red beans. FIG. 3 is a graph that compares contents of coarse tannin, tannin, coarse saponin, and ginsenoside in domestically grown (Korean) red beans D with the best quality and in the red bean sediment made from the same.

### Experimental Example 3

### Relation between the Number of Water Changing Operations and Contents of Tannin and Saponin

TABLE 3

| | Exp. 1 | Exp. 2 | Exp. 3 | Exp. 4 | Exp. 5 |
|---|---|---|---|---|---|
| Coarse tannin | 7.31 | 5.58 | 4.56 | 3.91 | 3.64 |
| Tannic acid | 0.71 | 0.52 | 0.40 | 0.32 | 0.28 |
| Coarse saponin | 2.61 | 1.85 | 1.59 | 1.52 | 1.47 |
| Ginsenoside | 0.20 | 0.09 | 0.05 | 0.03 | 0.03 |

From the result in Table 3, one can draw a conclusion that contents of tannin and saponin may be substantially reduced by increasing the number of water changing for making red bean sediment.

As explained so far, the present invention has been directed to the cooking process of red bean sediment for reducing an unpleasant and slightly bitter aftertaste of red beans by removing tannins and saponins contained in red beans through repetition of the water changing operation, the cooking process of red bean porridge with the red bean sediment, and red bean porridge. The present invention is a very advantageous invention in food industry in that the red bean porridge provides consumers with enhanced sensory attributes in terms of color and taste, which is achieved by minimizing contents of tannin and saponin causing the unpleasant aftertaste of the red bean porridge through a number of water changing operations between boiling of red beans.

Although the preferred embodiment of the present invention has been described, it will be understood by those skilled in the art that the present invention should not be limited to the described preferred embodiment, but various changes and modifications can be made within the spirit and scope of the present invention as defined by the appended claims.

What is claimed is:

1. A cooking process of red bean porridge made from a precooked red bean sediment, the red bean sediment being prepared by:
rinsing red beans, boiling the red beans in warm water (1^{st} boiling step), soaking the boiled red beans in room temperature-water so as to elute saponins and tannins from the red beans, and boiling again the red beans in warm water (2^{nd} boiling step);
draining the red beans having been boiled twice;
crushing the drained red beans and processing them with a finisher; and
changing water and dehydrating the processed red beans to obtain the red bean sediment.

2. The cooking process according to claim 1, wherein the step of crushing the drained red beans and processing the red beans with a finisher is repeated two to four times.

3. The cooking process according to claim 1, comprising:
adding sugar to the prepared red bean sediment and stirring the mixture to thereby make a sweetened red bean sediment; and
adding water into the sweetened red bean sediment, and simmering and stirring it until red bean porridge is fully cooked reaching desired consistency.

4. A red bean porridge providing enhanced sensory attributes, which is cooked by the process set forth in one of claims 1 to 3.
